(19) United States
(12) Patent Application Publication
(10) Pub. No.: US 2025/0229450 A1
(43) Pub. Date: Jul. 17, 2025

(54) ROLLING ANVIL CUTTER

(71) Applicant: Tamarack Products, Inc., Wauconda, IL (US)

(72) Inventors: David Machamer, Wauconda, IL (US); Bradley T. Boxrud, Wauconda, IL (US)

(21) Appl. No.: 19/025,092

(22) Filed: Jan. 16, 2025

Related U.S. Application Data
(60) Provisional application No. 63/621,701, filed on Jan. 17, 2024.

(51) Int. Cl. B26D 7/20; B26D 7/26

(52) U.S. Cl. CPC B26D 7/204; B26D 7/2614

(57) ABSTRACT

A device for cutting material includes a carriage comprising a connecting leaf, a blade, and an anvil. The blade is coupled to the connecting leaf, rotatable about a blade axis, and includes a cutting edge. The anvil is coupled to the connecting leaf, rotatable about an anvil axis, and includes an outer rim that is adapted to engage the cutting edge. The blade and the anvil are configured to rotate and cut material received between the cutting edge and outer rim, thereby introducing a cut line that forms substantially along a cut axis. A leading edge of the connecting leaf follows the cut line as it is formed and passes through the cut.

### CROSS-REFERENCE TO RELATED APPLICATIONS

This application claims the benefit of, and priority to, U.S. Provisional Patent Application No. 63/621,701 filed on Jan. 17, 2024, which is hereby incorporated by reference herein in its entirety.

### TECHNICAL FIELD

The present disclosure relates to cutting devices and, more particularly, an improved device for cutting a wide range of sheet and web materials adapted for uses in numerous consumer, commercial and industrial environments.

### BACKGROUND

The need to cut, trim and/or sever relatively thin web and sheet material is commonplace throughout homes, schools, businesses, and industry. For example, rolls of transparent web or film material may be consumed and subsequently spliced as film windows are applied to windowed folding cartons used for baked goods or other products. Webbing is also spliced in commercial printing applications, as well as those involving trimming of drawings, metering fabric, newsprint and dispensing of wrapping material for shipping, among many others. Consumers may choose to cut or trim paper, printed photos and other materials for craft projects and the like.

Existing devices and methods vary. These include freehand cutting with scissors or utility knives, guided means with office paper trimmers, and highly automated sheeting and splicing production machinery. There exists a need for an improved cutting device that can perform the cutting functions of a rotary pressure cutter without the need for significant overhead structure(s) or obstructions. Such an improved device should be capable of cutting a wide range of sheet and web materials adapted for uses in a variety of commercial and industrial environments with minimal injury risk.

### SUMMARY

According to certain aspects of the present disclosure, a device for cutting material comprises a carriage comprising a connecting leaf, a blade, and an anvil. The blade is coupled to the connecting leaf, rotatable about a blade axis, and includes a cutting edge. The anvil is coupled to the connecting leaf, rotatable about an anvil axis, and includes an outer rim that is adapted to engage the cutting edge. The blade and the anvil are configured to rotate and cut material received between the cutting edge and outer rim, thereby introducing a cut line that forms substantially along a cut axis. A leading edge of the connecting leaf follows the cut line as it is formed and passes through the cut.

According to certain aspects of the present disclosure, a device for cutting material comprises a carriage including a connecting leaf. A first blade is coupled to the connecting leaf, rotatable about a blade axis, and includes a first cutting edge. A second blade is coupled to the connecting leaf, rotatable about an anvil axis, and includes a second cutting edge. The first cutting edge is adapted to engage the second cutting edge. When the carriage travels in a first direction, the first and second blades rotate and impart a shearing force that cuts material received between the first and second cutting edges, thereby introducing a cut line that forms substantially along a cut axis. A leading edge of the connecting leaf follows the cut line being formed and passes through the cut.

According to certain aspects of the present disclosure, a device for cutting material comprises a carriage having a blade housing and an anvil housing. The blade housing and the anvil housing are connected by a connecting leaf. A blade is rotatably coupled to the blade housing about a blade axis via a blade centering assembly, the blade including a cutting edge. An anvil is rotatably coupled to the anvil housing about an anvil axis, the anvil including an outer rim configured to engage the cutting edge. The blade and the anvil are configured to rotate and cut material received between the cutting edge and outer rim, thereby introducing a cut line that forms substantially along a cut axis. A leading edge of the connecting leaf follows the cut line as it is formed and passes through the cut.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments and are therefore not to be considered as limitations on the scope of the various embodiments or claims.

FIG. 1 is an isometric view of an exemplary arrangement for a cutting device, according to certain aspects of the present disclosure.

FIG. 2 is a partially exploded partial isometric view of the exemplary arrangement for the cutting device of FIG. 1 with upper and lower leaf clamps separated from the leaf, according to certain aspects of the present disclosure.

FIG. 3 shows a cross sectional view of the exemplary arrangement for the cutting device of FIG. 1 taken along line 3-3 shown in FIG. 1, according to certain aspects of the present disclosure.

FIG. 4A is a schematic end view of the exemplary arrangement for the cutting device of FIG. 1, according to certain aspects of the present disclosure.

FIG. 4B is a schematic side view of the exemplary arrangement for the cutting device of FIG. 1, according to certain aspects of the present disclosure.

FIG. 4C is a schematic top view of the exemplary arrangement for the cutting device of FIG. 1, according to certain aspects of the present disclosure.

FIG. 5 is a schematic of the exemplary arrangement for the cutting device of FIG. 1 being used with a window patching machine, according to certain aspects of the present disclosure.

FIG. 6A is a schematic top view of an exemplary alternative arrangement for a cutting device, according to certain aspects of the present disclosure.

FIG. 6B is a schematic end view and side view of the exemplary alternative arrangement for a cutting device of FIG. 6A, according to certain aspects of the present disclosure.

FIG. 6C is an enlarged view of the end view of the exemplary alternative arrangement for a cutting device of FIG. 6B, according to certain aspects of the present disclosure.

FIG. 7A is a schematic top view of another exemplary alternative arrangement for a cutting device, according to certain aspects of the present disclosure.

FIG. 7B is a schematic end view and side view of the exemplary alternative arrangement for a cutting device of FIG. 7A, according to certain aspects of the present disclosure.

FIG. 8A is a schematic top view of yet another exemplary alternative arrangement for a cutting device, according to certain aspects of the present disclosure.

FIG. 8B is a schematic end view and side view of the exemplary alternative arrangement for a cutting device of FIG. 8A, according to certain aspects of the present disclosure.

FIG. 9A is a schematic top view and side view of an exemplary arrangement for a cutting device showing the cutting device just prior to engagement with a material to be cut, according to certain aspects of the present disclosure.

FIG. 9B is a schematic top view and side view of the exemplary arrangement for the cutting device of FIG. 9A showing the cutting device while cutting the material to be cut, according to certain aspects of the present disclosure.

FIG. 10A is a schematic top view of an exemplary arrangement for a cutting device showing the cutting device just prior to engagement with a material to be cut, according to certain aspects of the present disclosure.

FIG. 10B is a schematic side view of the exemplary arrangement for the cutting device of FIG. 10A showing the cutting device just prior to engagement with a material to be cut, according to certain aspects of the present disclosure.

FIG. 11 is a schematic side view of another exemplary alternative arrangement for a cutting device, according to certain aspects of the present disclosure.

FIG. 12 is a schematic end and side view of an exemplary alternative arrangement for a cutting device having a blade below and an anvil above a support surface, according to certain aspects of the present disclosure.

FIG. 13A is a schematic end view of an exemplary rotary shear cutting arrangement for a cutting device, according to certain aspects of the present disclosure.

FIG. 13B is a schematic end view of another exemplary rotary shear cutting arrangement for a cutting device, according to certain aspects of the present disclosure.

FIG. 13C is a schematic end view and side view of another exemplary rotary shear cutting arrangement for a cutting device, according to certain aspects of the present disclosure.

FIG. 14 is a schematic side view of an alternative arrangement for a cutting device including a braking assembly, according to certain aspects of the present disclosure.

FIG. 15A is a plan view of a blade centering assembly, according to certain aspects of the present disclosure.

FIG. 15B is a cross-sectional view taken generally along the lines 15B-15B of the blade centering assembly of FIG. 15A, according to certain aspects of the present disclosure.

FIG. 16 is a perspective view of the blade centering assembly of FIGS. 15A and 15B aligned for coupling with the blade housing, according to certain aspects of the present disclosure.

FIG. 17 is a perspective view of the blade centering assembly of FIGS. 15A and 15B in contact with the blade housing during mounting, according to certain aspects of the present disclosure.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

Two common types of office paper trimmers include: (i) a guillotine shear cutting trimmer, and (ii) rotary blade pressure cutting trimmer. The guillotine trimmer typically consists of a handle-equipped pivoting arm, which operates orthogonally to a horizontal support table. A single-beveled blade along the lower edge of the pivoting arm is lightly side loaded against a fixed blade situated along the edge of the support table. When pivoted downward, the blade edge of the arm passes adjacent to the fixed blade edge, creating a shearing cut zone which progresses away from the pivot as the arm is lowered. However, the guillotine trimmer requires an overhead guard rail structure to protect against injury, which impedes hand and finger access. Further, the blade, itself, must be long enough to span the entire sheet or web. It must necessarily approach the cut from overhead, leaving a gap in-between and presenting a significant safety hazard. Also, the long cutting edges involved are prone to nicking and wear, and are somewhat difficult to maintain.

Rotary blade pressure cutting provides simple, reliable severing of a wide range of materials with minimal disturbance. Such devices typically consist of a movable carriage which houses a rotary, center-bevel edged blade oriented at a right angle to a horizontal support table. The carriage slides or rolls along a raised rail at a short elevation above the support table, sometimes, but not necessarily near an edge. Below and in line with the rail, the support table includes an anvil surface which may be hardened to resist penetration by the blade, or compliant, to allow slight penetration. The carriage is suspended on the rail with light, upward spring pressure to hold the blade above and out of contact with the anvil surface when at rest. In use, material is placed on the support table and slid underneath the rail to rest atop the anvil surface. Here, too, the material is located against a squaring surface or otherwise aligned and positioned. The carriage is manually pressed downward to radially load the blade against the anvil surface and induce it to roll as it is drawn through the material. Despite the advantages associated with rotary pressure cutters, the direct rolling pressure experienced by a rotary blade (where a sharp circular edge presses on a flat surface) can lead to accelerated dulling of the blade and wear on the opposing anvil surface.

Another traditional approach (more common to industrial or commercial applications) is rotary shear cutting. Like the rotary blade pressure trimmer, a rotary shear cutter relies on a support table and rail suspended carriage. However, instead of featuring a centered, knifelike edge, a rotary shear cutter uses a single-beveled disc. Further, the support table of a rotary shear cutter includes a rectangular fixed blade rather than a flat anvil surface. In use, the carriage is manually pressed downward and biased sidewise so that the edge of the rotary blade partially penetrates the plane of the support table and securely presses against the side of the fixed blade. As the carriage is drawn over the material, friction against the side of the fixed blade and, to some extent, resistive forces exerted by the material induce rotation of the rotary blade as it proceeds through the material to produce a well-controlled, guided cut. However, the angle at which the rotary cutting edge meets the material is more obtuse than that of a direct-rolling pressure cutting blade. Further, the in-running velocity of the rotary edge tends to be slower than the translation velocity of the carriage due to slippage between the rotary and stationary blades. Both factors act to increase the reaction forces that tend to reject the material from the cut zone (sometimes referred to as rejection forces). Such rejection forces can cause sliding, lifting, and/or bunching of the material, which decreases the likelihood of achieving a clean, high-quality cut.

Notably, each of the conventional solutions discussed above rely on numerous structural elements disposed above the support table for supporting, guiding, guarding, and actuating functions. These overhead elements are typically disposed directly above or very near to the cutting path, and may include raised rails, guard rails, overhead blades, and the like. The pivoting arm of the guillotine trimmer also resides and operates overhead. Additionally, and perhaps more notably, each of the conventional solutions require that operators place their hand above the support table to actuate and/or provide contact pressure.

Additional overhead elements are needed if automated actuation is desired. These may include, for example, an overhead pneumatic cylinder or electric linear actuator to automatically cause a pivoting arm to pivot toward the web material or shuttle a movable carriage. Such devices are somewhat bulky and would likely need to operate remotely so as not to hinder physical or visual access to the cutting area by mounting overhead. Exposed actuators and their connections can introduce their own hazards such as “pinch” and “crush,” and may need additional guarding. Further, a sturdier, bulkier rail construction may be needed to maintain adequate pressure for cutting in conventional, automated solutions.

The presence of overhead elements can impede the ability to load, place, handle, and/or remove material in the cutting area, functions that are critical in many web-consuming applications. For example, a window applicator machine, such as Tamarack's Vista® window applicator can apply window film or webbing to hundreds of folded carton packages each minute. Doing so can consume multiple rolls of webbing each hour, and each such instance requires a splicing operation to replace expired rolls. In each such instance, the web of an expired roll needs to be neatly cut away and its tail end abutted to the neatly trimmed lead end of a replenishing web before splicing tape can be applied.

An exemplary splicing sequence involves the following:

1. Bringing the web consuming machine to a stop.

2. Clamping or holding expired webbing against a support table to the downstream side of the intended splice.

3. Severing the expiring web with a guided cut across its width and removing the expired roll core and waste material. In manual terms, such a cut can be made by dragging the edge of a utility knife along a groove in the support table.

4. Loading the replenishing roll and routing the lead end of the replenishing web to the splice point where it is intentionally overlapped with the cut end of the expired web.

5. Clamping or holding the replenishing web against the support table to the upstream side of the intended splice and severing its lead end with a second guided cut. This cut is coincident with the severed end of the expired web. Removing trimmed waste while leaving in place the closely matched ends of the two webs.

6. Applying adhesive tape along the resultant joint line and ironing in place.

7. The web is unclamped, and the machine is restarted.

The above exemplary splicing sequence helps illustrate the value of physical and visual access in the vicinity of the cutting path. In step 4, the replenishing web must be introduced and laid flat on top of the expired web. Any structure above the cutting path would be a hinderance as it would require the lead end of the replenishing web to be carefully threaded underneath the structure, but still above the expired web. Step 6 requires direct access to the cutting path so that tape may be applied correctly. An overhead structure in this area would make the task difficult if not completely impractical.

Web cutting devices with limited overhead structure are known. These include a guided rigid knife cutting device, which relies on a thin knife blade protruding upward through a slot. The method relies on the sharpness of the blade and the ability for the material to stay positioned to achieve adequate severing stress. In most cases, substantial means for external restraint are necessary to pin or clamp the material in position as the blade enters and progresses through the cut. Rapid blade wear is also a concern. The fine edge angles needed for clean cutting are fragile and especially vulnerable to nicking and dulling. Additionally, all contact with the material occurs in a single, concentrated region of the cutting edge, further accelerating wear. Further, in rigid knife cutting, the blade alone engages the material, which can produce high rejection forces resulting in material crumpling and failed cuts, particularly for thinner and/or more flexible material.

An improved device for cutting a wide range of sheet and web materials is disclosed. A dual-bodied carriage, consisting of an anvil roller housing and an opposed rotary blade housing, translates along an intermediate slotted support table. The opposed housings are connected by a thin tensile leaf extending through the slot. Translating motion is provided by any of various actuating means on the remote, anvil side of the support table. The anvil roller is positively loaded against its corresponding side of the support table to either side of the slot and rolls in conjunction with the motion of translation. The circular cutting edge of the rotary blade lies in the midplane of the connecting tensile leaf and is radially loaded against the outer rim of the anvil roller where it adjoins the slot. The circumferential outer rim of the anvil roller protrudes through the slot where it engages the cutting edge of the rotary blade. In certain exemplary embodiments, pressure of the blade against the rolling anvil's outer rim induces a positive and advantageous rolling action to the blade itself and creates an in-running, over-speed pulling effect and pressure cutting zone near and at the point of contact.

A sheet, or web of material laid in or near the plane of the cutting zone is severed when encountered by the translating carriage. As severing progresses, the trailing tensile leaf is enabled to follow within the concurrently forming split in the material. When cutting is completed, either fully or partly across the material, the carriage can be retracted from the material, passing freely backward within the extant split.

In one aspect, the cutting device of the present disclosure provides a well-controlled, versatile, inherently safe cutting means capable of severing a wide range of materials with minimal need for additional effort or structure to control the material. The disclosed arrangement provides maximal visual, manual, and material access to the cutting path and associated working area, In the splicing of web materials, for instance, the sequence of steps required to control, trim, position, and join benefit greatly from a controlled cut in an unobstructed working area.

In another aspect, the cutting device of the present disclosure uses cutting mechanics compatible with a wide range of materials. The use of rotary pressure cutting provides this advantage. Adding a condition for over-speed, in-running behavior increases this advantage.

A further aspect of the cutting device provides a self-supporting pressure cutting mechanism requiring no external structures to maintain cutting pressure between blade and anvil elements, as all pressure forces are carried by the integral connecting leaf. Thus, the working area remains wide open and unobstructed.

A further aspect of the cutting device provides an integral support structure slender enough to pass through the material for continuous severing. This is accomplished by the connecting leaf which is sufficiently strong while similar in thinness to a razor blade.

In a further aspect, the cutting device is sufficiently compact to readily integrate with existing machinery. The core elements of actuation, guiding and cutting can be arranged to fit within a confined space. Overall length of an integrated system need not greatly exceed the designed cutting distance. A free-standing, unitized cutting apparatus, containing all required elements for a working system, can be concentrated into an efficient rail like carriage or cartridge.

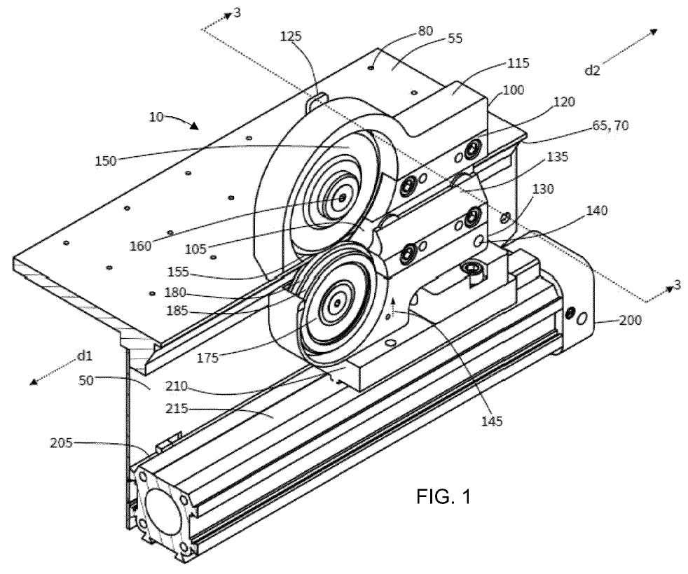

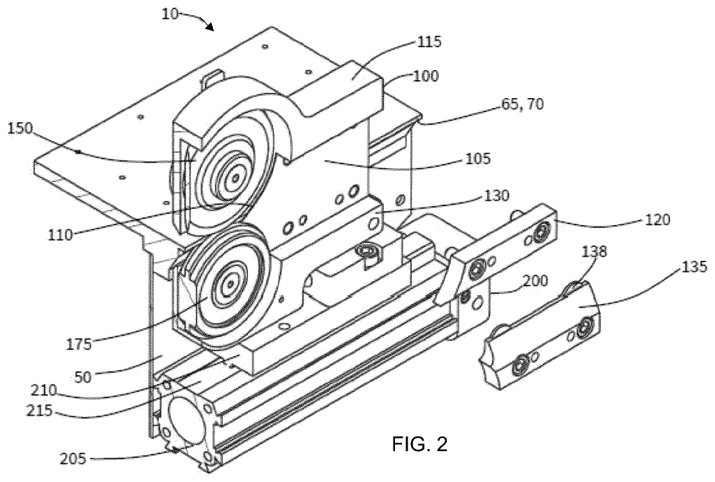

Referring generally to FIGS. 1-3, in an embodiment a cutting device 10 includes a base 50 and support table 55. Vacuum holes 80 may be drilled into the support table 55 to hold material (not shown in FIGS. 1-2) in place, a feature particularly useful for splicing film. An edge or wall 70 on one side of the support table 55 is contoured to provide one side of a guide slot 65. An edge on a second side of the support table 55 (not shown in FIGS. 1 and 2), provides the other side of the guide slot 65, producing a slot gap approximately 0.080″ wide in some embodiments. A carriage assembly 100 (described in more detail below) uses the guide slot 65 as a track to travel along.

A dual-bodied carriage 100, includes a blade housing 115 and an anvil housing 130. In an embodiment the blade housing 115 is disposed above the support table 55, and the anvil housing 130 is disposed below the support table 55. In another embodiment, the anvil housing 130 is disposed above the support table 55, and the blade housing 115 is disposed below the support table 55. The blade and anvil housings 115, 130 are disposed on opposing ends of a connecting leaf 105, which may be constructed of a relatively thin plane of material. In an embodiment, one end of the anvil housing 130 is pivotably connected to a shuttle carriage 210 by a pivot element 140, thereby permitting the anvil housing 130 to pivot. A resilient element, for example without limitation, a spring 145, urges a free end of the anvil housing 130 upwardly toward the support table 55.

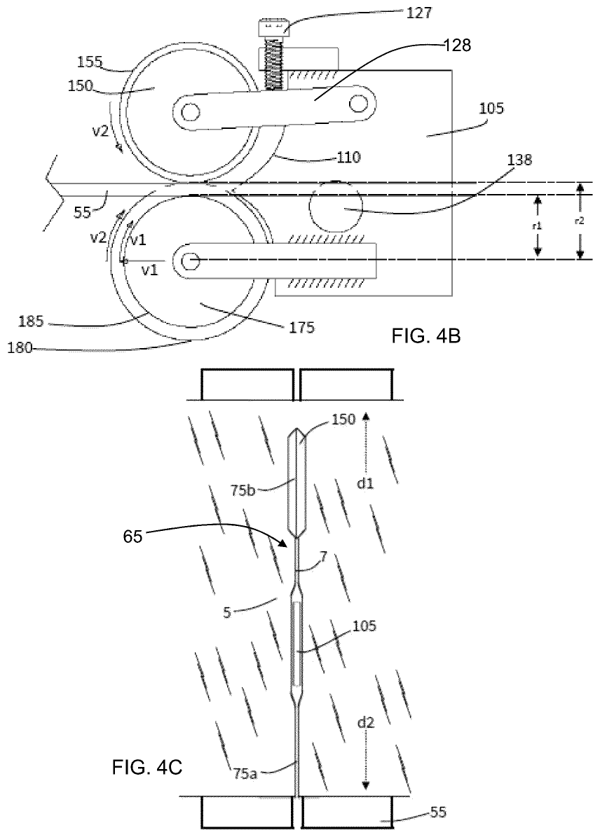

In an embodiment, the connecting leaf 105 is sufficiently thin to not only travel through the guide slot 65, but to also travel cleanly between (and avoid disturbing) the cut sides of the severed material 5, as shown in in FIG. 4C. In an embodiment, the connecting leaf 105 is constructed of strong, high performing rigid material, such as blue tempered and polished spring steel with thickness of approximately 0.010 inches. In other embodiments the connecting leaf 105 is constructed of other rigid material and has a thickness other than 0.010 inches. The leaf 105 can be produced to extremely high precision via wire EDM machining, which can achieve incredible precision on largely two-dimensional parts.

Referring to FIG. 2, upper and lower leaf clamps 120, 135 are positioned within and removably fastened to respective steps formed in the blade and anvil housings 115, 130 to secure them against the connecting leaf 105, for example, using locating pins, threaded fasteners and/or other well-known fastening means. As shown most clearly in FIG. 2, in an embodiment the lower leaf clamp 135 includes sliding guides 138 (which can be in the form of rotating disks or other shapes) protruding from the top of the lower leaf clamp 135. The sliding guides 138 keep the leaf 105 centered within the slot 65 travelling between (and potentially grazing) the walls 70 of the slot 65.

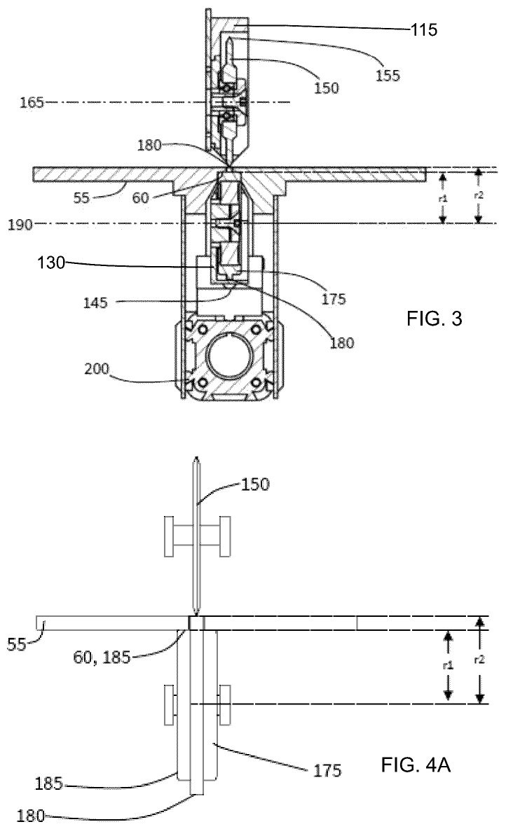

Referring to FIG. 3, in an embodiment, a substantially circular blade 150, configured to rotate about a blade axis 165, is rotatably coupled to the blade housing 115, for example, using an eccentric hub 160. In an embodiment, a lever 125 (shown in FIG. 1) rotates the eccentric hub to adjust positioning and/or pressure of the blade 150. In an embodiment, positioning and/or pressure of the blade 150 is adjusted using a threaded adjustment screw 127, which engages a pivoting link 128, as shown in FIG. 4B. The blade 150 is beveled and/or sharpened in a manner that forms a cutting edge 155 along the blade's outer perimeter.

Still referring to FIG. 3, in an embodiment, substantially circular anvil 175, configured to rotate about an anvil axis 190, is rotatably coupled to the anvil housing 130. In the embodiment of FIGS. 1-4B, the anvil 175 includes an annular outer rim 180 disposed at the anvil's larger outer radius (r2) and annular inner rims 185 formed along a smaller inner radius (r1).

In various embodiments, the cutting device 10 can be manually operated or automated through use of an automated drive assembly 200 or the like. For example, the embodiment of FIGS. 1-3 includes on a commercially available rodless pneumatic cylinder 205 (such as the Parker Hannifin Corporation OSPP16510 rodless air cylinder) to effectuate automated movement of the carriage 100 (although other forms of automated drive means may be used as well). In the embodiment of FIGS. 1-3, the carriage 100 is removably mounted to a shuttle carrier 210, which travels along a track 215 of the pneumatic cylinder 205 fixed to the base 50. Compressed air causes the shuttle 210 (and, consequently, the carriage 100) to move from a first position (for example, 75a shown in FIG. 4C) to a second position (for example, 75b shown in FIG. 4C) along the track 215. A control (not shown), in the form of a push button valve or the like, may be used to actuate the automated drive assembly 200 in a well-known manner.

Referring to FIG. 4C, in operation, the blade 150 cuts material 5 and introduces a cut line 7 as it travels in direction (d1) from its first position 75a to its second position 75b along the slot 65. The connecting leaf 105 is aligned with the cutting edge 155 of the blade 150 along the direction of travel and is situated to trail behind the blade 150 as it introduces the cut line 7 in the material 5. Once the material 5 is fully cut, the carriage 100 subsequently travels in the opposite direction (d2) as the carriage returns to the first position 75a.

As the cut is made and cut line introduced 7, newly formed edges of the severed material 5 may flow upward along a curved surface or ramp 110 formed along the leading edge of the connecting leaf 105. As shown in FIG. 4B, the curve of the ramp 110 generally follows the contours of the blade 150 both above the surface of the support table 55 and continuing through the slot 65 to a point intentionally below the surface of the support table 55. The ramp 110 urges the newly forming edges of the splitting material 5 upwardly to assist flow around the leaf 105. The ramp feature may be introduced to any cutting device embodiment of the present disclosure, even if not expressly depicted in a figure.

The spring 145 biases the anvil 175 and inner rims 185 toward the support table 55. As shown most clearly in FIGS. 4A and 4B, the inner rims 185 contact rail surfaces 60 formed on the underside of the support table 55, such that linear movement of the shuttle carrier 210 (and in-turn, the carriage 100), will cause the anvil 175 to rotate. In an embodiment, a layer of rubber or other gripping material is applied to the inner rims 185 to ensure they grip and maintain continuous contact with the rail surfaces 60 as the carriage 100 travels. Such contact compels the anvil 175 to rotate at a rate consistent with that at which each inner rim 185 rolls against its corresponding rail surface 60. In conjunction, the outer rim 180 contacts the cutting edge 155 of the blade 150, thereby causing the blade 150 to rotate.

It will be appreciated that the arrangement depicted in FIGS. 4A and 4B produces an over-speed, in-running cutting action that inherently pulls material 5 into the cutting edge 155 (and toward the connecting leaf 105), as it is being severed. The pulling force applied to the material 5 may act to subdue disturbances, such as sliding, lifting, and bunching and increase the likelihood of achieving a clean, high-quality cut.

As shown in FIG. 4B, the outer rim 180 follows a radius (r2) that is greater than those of the inner rims 185 (r1), which means that the tangential velocity of the outer rim 180 is also greater. The carriage 100 traveling along the slot 65 at a speed and direction (v1) causes the tangential velocity of the inner rim 185 to be the same (also v1) as it rolls against the rail surface 60. However, the tangential velocity of the outer rim 180 (v2) and, consequently, tangential velocity of the cutting edge 155 (also v2) will be greater, thereby producing an over-speed pulling effect. As the carriage travels toward second position in direction (d1) the difference between the tangential velocities (v2−v1) results in the portion of the cutting edge 155 contacting the material 5 to pull the material 5 in the opposite direction (back toward the first position), in addition to pressing down on the material 5. This over-speed pulling effect offsets some of the naturally occurring rejection force associated with the advancing cut. Such an advantage is not readily available for common rotary pressure cutting against a stationary anvil surface, which merely presses down on the material 5.

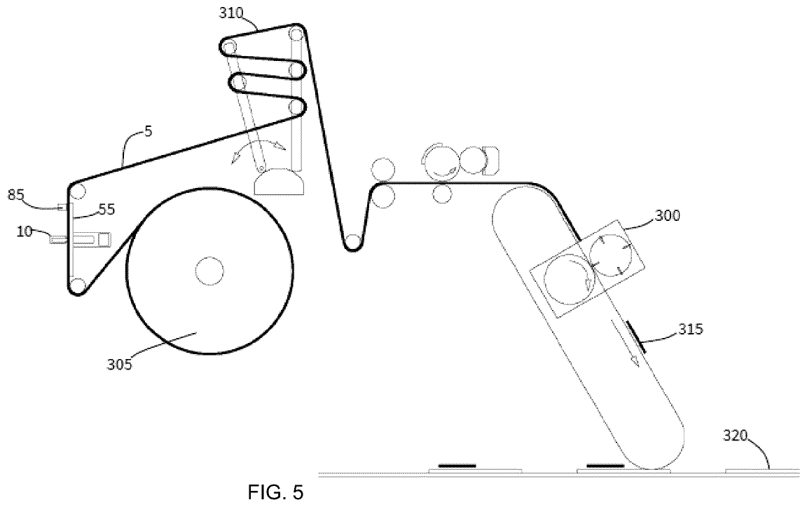

As shown in FIG. 5, the cutting device 10 of the present disclosure can be implemented to perform a splicing function and/or feature associated with commercial or industrial manufacturing processes, including those involving a window applicator machine 300, such as Tamarack's Vista® window applicator, (an example of which is described in U.S. Pat. No. 6,772,663, incorporated in its entirety by reference herein). In one exemplary implementation, webbing or film material 5 is fed from a roll 305 and routed over the support table 55 of the cutting device 10. In some implementations, the webbing may be routed under a web clamp 85 (in the form of a roller extending along the length of the support table 55, or the like) to further secure the film 5 in the manner shown in FIG. 5. Next, the film 5 passes through a tensioned accumulator 310 before entering a window applicator machine 300, where film segments 315 are applied to form windows of folded cartons 320.

When the roll 305 expires and needs replacement, the operator first confirms that the web clamp 85 (shown in FIG. 5) is engaged and vacuum is activated to ensure the film 5 is secured against the support table 55. Next, the operator actuates a control (not shown) of the automated drive assembly 200 to cause the blade 150 to make a first splicing cut as it travels from first position 75a to second position 75b before returning to first position 75a. After the first splicing cut is made, one free end of the film 5 is held against the support table 55 by the web clamp 85 and vacuum, while the other free end (on the roll side) can be discarded along with the expired roll. Next, the operator feeds a leading edge of a replacement roll across the slot 65 toward the web clamp. Next, the operator actuates the control to cause a second cut to be made across the replacement film. Once the second cut is made, the free ends of the expired and replacement rolls (both with clean, exact, square cuts) are held in place by vacuum against each other. The operator then applies adhesive tape or the like, thereby completing the splicing step.

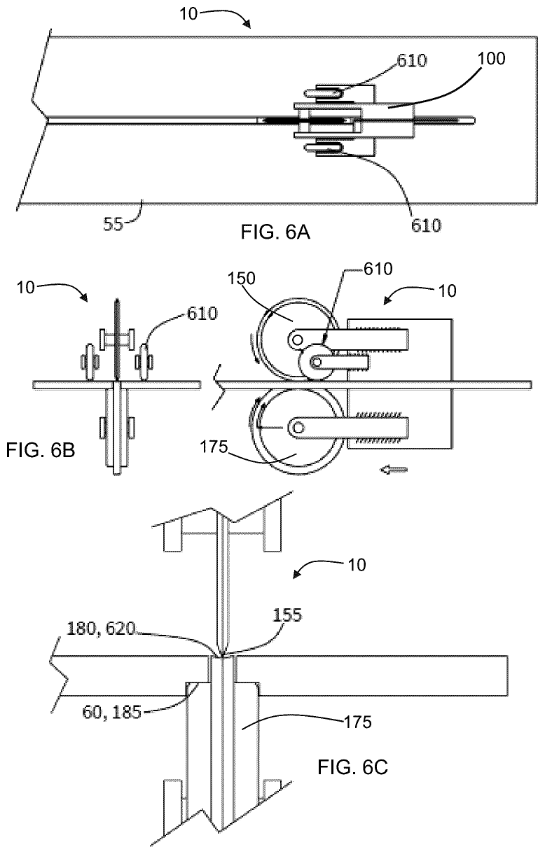

FIGS. 6A, 6B and 6C show an alternative arrangement for the cutting device 10 in accordance with the present disclosure. In this embodiment, the carriage 100 includes pinning wheels 610 disposed on either side of the connecting leaf 105 to provide further stability. Additional stability can also be achieved by introducing a “V” shaped circumferential depression or groove 620 in the outer rim 180 of the anvil 175 in the manner shown in FIG. 6C. In this arrangement, the cutting edge 155 biases toward the lowest point of the groove 620 to urge the blade 150 toward its centered position and further reduce the risk of unwanted lateral movement.

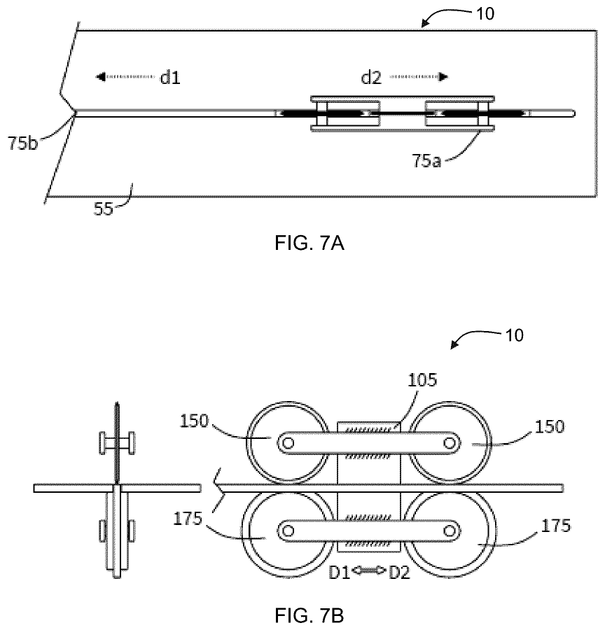

FIGS. 7A and 7B show another alternative arrangement for the cutting device 10 in accordance with the present disclosure. The blade and anvil pairings 150, 175 are disposed on both sides of the connecting leaf 105, such that the device can apply a cut when the carriage 100 travels in a first direction D1 and/or in a second direction D2. In one aspect, operators may promote efficiencies by (i) applying a first cut in the first direction D1, (ii) advancing the material 5 and (iii) applying a second cut when the carriage 100 returns in the second direction D2. In another aspect, operators using the cutting device 10 to apply cuts only in a single direction (i.e., the first direction D1) for a first process may optionally re-purpose the same cutting device to 10 to apply cuts in a second direction D2 for a second process with few (if any) modifications. Ramps (not shown), such as the ramp 110 shown in FIGS. 2 and 4B, may be formed or otherwise disposed on opposing sides of the connecting leaf 105 of the embodiment of FIGS. 7A and 7B.

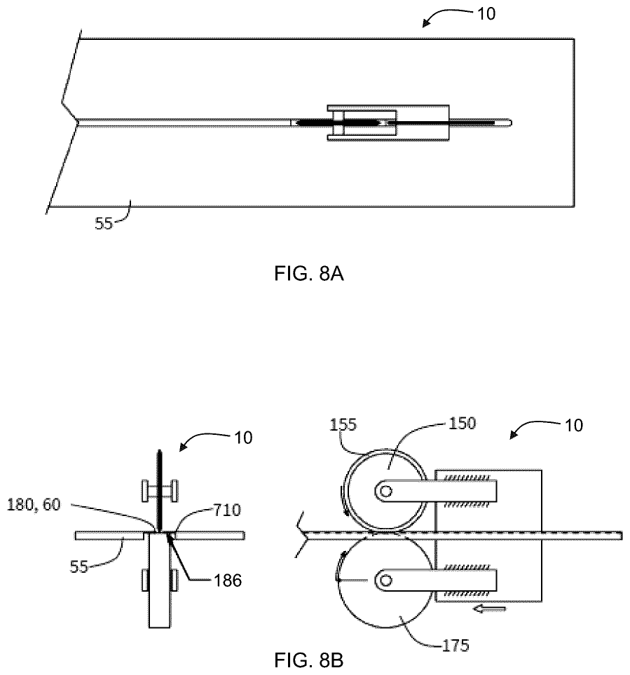

Embodiments of the cutting device 10 of the present disclosure may operate with the blade's cutting edge 155 and outer rim 180 operating on-speed, rather than over-speed, without use of an anvil inner rim 185. For example, in the embodiment of FIGS. 8A and 8B, the outer rim 180 itself (rather than the inner rims 185) directly contacts the rail surfaces 60 on the underside of the support table 55, as indicated by the arrow 186. The carriage 100 traveling along the slot 65 at a speed and direction (v1) causes the tangential velocity of the outer rim 180 and cutting edge 155 to be the same (also v1) as it rolls against the rail surface 60. In this embodiment, stepped portions 710 may be formed, such that the portions of the support table 55 forming the rail surfaces 60 are narrower or thinner than other portions. As shown in FIG. 8B, the cutting edge 155 of the blade leans into the slot 65 and directly contacts the outer rim 180 of the anvil where the cut is being made.

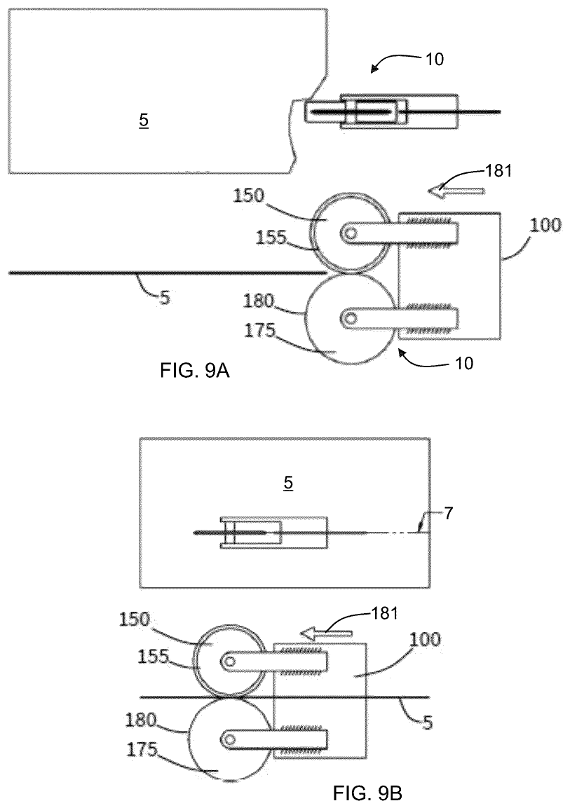

FIGS. 9A-11 show additional alternative arrangements for embodiments of the cutting device 10 that operate without a support table. These embodiments are similar to the embodiment of FIGS. 8A and 8B as they operate without use of an anvil inner rim 185. Such embodiments are most suitable for use with rigid materials, such as heavy paperboard, thick plastic film or the like, as the material 5 itself is at least partially self-supporting. While not shown in FIGS. 9A-11, such embodiments can be connected to a base and manually operated or automated through use of an automated drive assembly 200. FIG. 9A illustrates the cutting device 10 just before contacting the material 5 to be cut, and FIG. 9B illustrates the cutting device 10 moving in the direction of arrow 181 in the process of cutting the material 5 along the cut line 7.

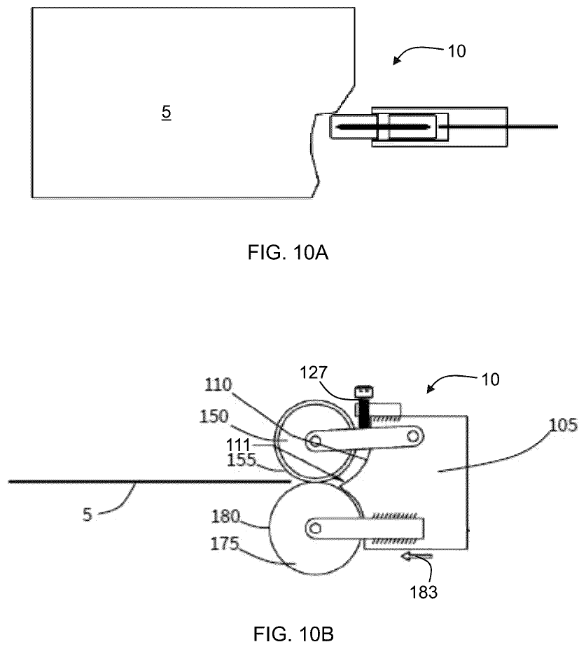

FIGS. 10A and 10B illustrate schematic top and side views of an exemplary arrangement for a cutting device 10 showing the cutting device 10 just prior to engagement with a material 5 to be cut. As the cutting device 10 is moved in the direction of arrow 183, the material 5 is cut, and the ramp 110 of the connecting leaf 105 urges the newly forming edges of the splitting material 5 upwardly to assist flow around the connecting leaf 105. In this embodiment the ramp 110 includes a pointed transition 111 to a lower part of the ramp that 110 that is further configured to urge the newly forming edges of the splitting material 5 downwardly to assist flow around the connecting leaf 105.

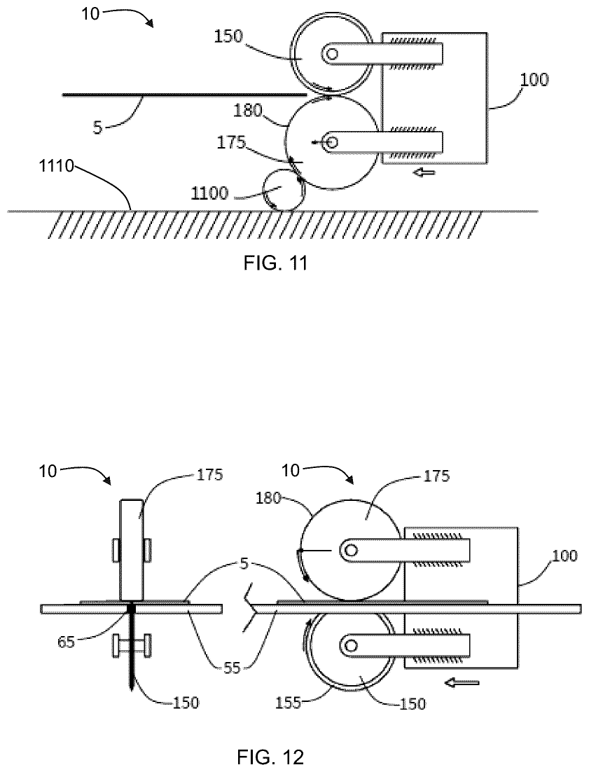

Referring to FIG. 11, in an embodiment the cutting device 10 includes a traction roller 1100, which rolls against an alternative surface 1110, thereby causing the anvil 175 to rotate. The anvil's rotation causes the carriage 100 to travel as the anvil's outer rim 180 grips the material 5. Alternatively, the traction roller 1100 itself may be powered, which may obviate the need for a separate automated drive assembly. In other embodiments, the anvil 175 can also be driven to rotate by a belt, a cable, a gear rack, or the like.

Referring to FIG. 12, another alternative arrangement for the cutting device 10 in accordance with the present disclosure is shown. This embodiment is similar to the embodiment of FIGS. 8A and 8B as it operates without use of an anvil inner rim 185. However, in this embodiment, the anvil 175 is disposed above the support table 55 (on the material side). The anvil's outer rim 180 biases against and secures the material 5 against the support table 55, while the cutting edge 155 of the blade leans upwardly into the slot 65 where it directly contacts the outer rim 180 as the cut is being made. This embodiment may be suitable for thin/flimsy fabric prone to disturbances, such as diaper liner material.

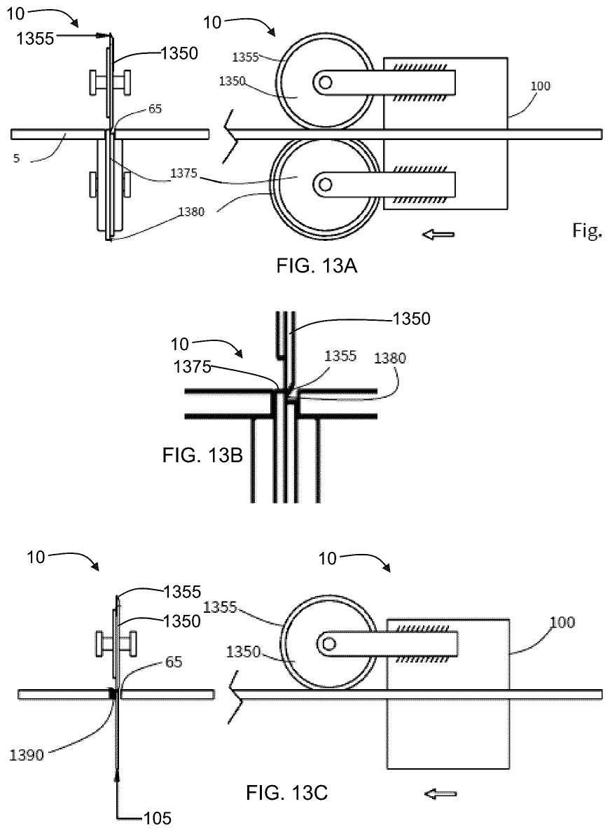

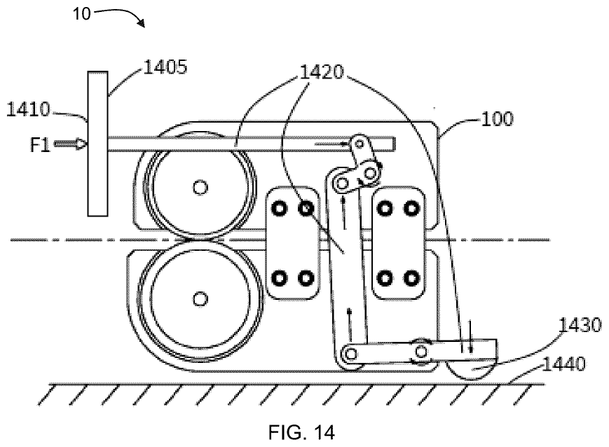

Aspects of this invention can be implemented with a rotary shear cutting arrangement. In the embodiment of FIGS. 13A and 13B, material 5 is sheared by a single beveled cutting edge 1355 of a male rotary knife or blade 1350 rotatably engaging the stepped portion 1380 of a female rotary knife or blade 1375 as the carriage 100 travels. In the embodiment of FIG. 13C, shearing occurs as the single beveled cutting edge 1355 of a male rotary knife or blade 1350 engages a rigid or fixed lower blade 1390 disposed along the slot.

As shown in FIG. 14, embodiments of the carriage 100 may be optionally equipped with a friction braking assembly 1405 to reduce momentum or motion as desired. The braking assembly 1405 may be actuated by applying force F1 to an actuation member 1410. The force F1 translates to a series of linkages 1420 (which may be arranged in the exemplary manner shown in FIG. 14) and, ultimately, a friction member 1430, such as a brake pad. Braking occurs as the friction member 1430 engages a surface 1440 in a well-known manner.

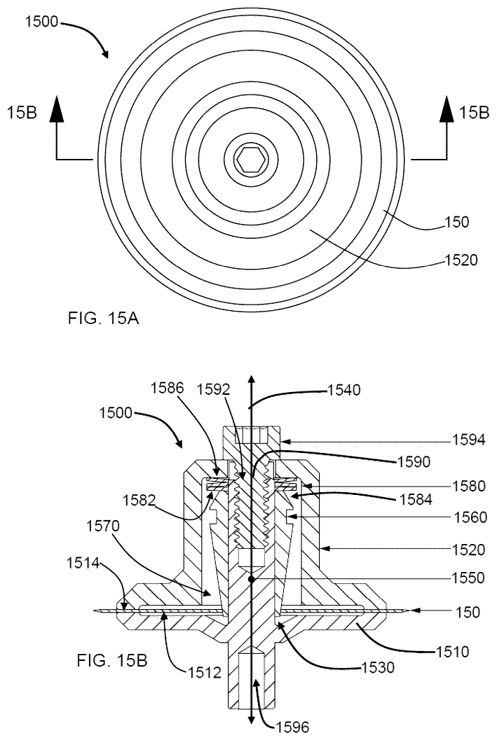

Referring to FIGS. 15A and 15B, an embodiment of a blade centering assembly 1500 is shown in plan view in FIG. 15A and in cross-section in FIG. 15B. It has been found that blade concentricity is an important consideration both for achieving a long lifespan (>50,000 cycles) for the blade 150, and also for making high-quality cuts. To facilitate and maintain a high degree of blade concentricity, the blade centering assembly 1500 secures the blade 150 to the blade housing 115. The blade 150 is securely held between a blade collar 1510 (not visible in FIG. 15A) and a centering clamp 1520.

The internal structure of the blade centering assembly 1500 is visible in FIG. 15B. The blade 150 includes a center bore 1530 that includes the blade axis 165. The blade collar 1510 is configured to contact a first side 1512 of the blade 150. The blade collar 1510 includes a spindle shaft 1550 configured to pass through the center bore 1530. A collet 1560 is disposed around the spindle shaft 1550 and configured such that a first tapered end 1570 of the collet 1560 is disposed within the center bore 1530 of the blade 150.

At least one Belleville washer 1580, or other compressible washer, is disposed around the spindle shaft 1550 such that a first side 1582 of the Bellevue washer 1580 faces a second end 1584 of the collet 1560. The centering clamp 1520 is disposed around the spindle shaft 1550 and facing a second side 1586 of the Bellevue washer 1580. A threaded fastener 1590 is threadably disposed into a recess 1592 in the spindle shaft 1550 such that a head 1594 of the threaded fastener 1590 forces the centering clamp 1520 into engagement with a second side 1514 of the blade 150 against a bias of the at least one Bellevue washer 1580.

As can be seen in FIG. 15B, when the threaded fastener 1590 is tightened, the at least one Belleville washer 1580 is compressed, and the collet 1560 is pressed firmly into the center bore 1530 of the blade 150. This action centers the blade 150 to be concentric with the spindle shaft 1550 of the blade collar 1520. As the threaded fastener 1590 is tightened, the centering clamp 1520 clamps down onto the blade 150, securing the blade 150 concentrically in place. The first tapered end 1570 of the collet 1560 allows for the use of various blades 150 having deviations in the diameter of the center bore 130 to still be able to be centered. This is useful, for example, for blades 150 acquired from different manufacturers and/or having different diameters of their center bores 1530. The first tapered end 1570 of the collet 1560 also allows for blades 150 with specific properties to be selected, which can maximize the cut quality on materials specific to a job, without having to sacrifice concentricity due to varying tolerances between manufacturers.

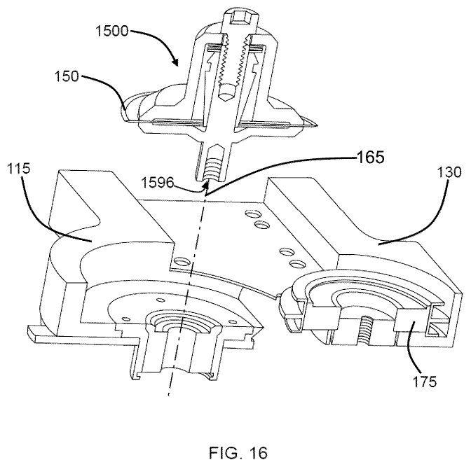

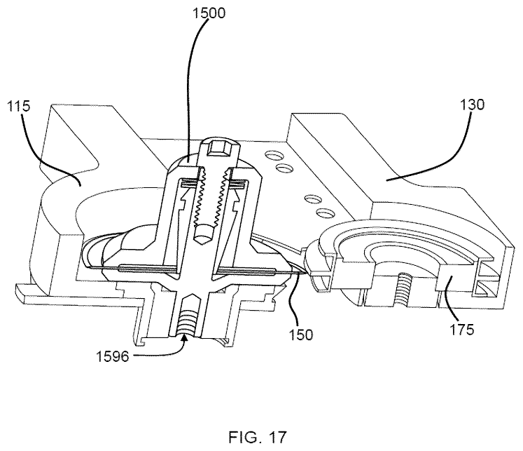

Referring to FIG. 16, the assembled blade centering assembly 1500 with the blade 150 secured within is shown aligned along the blade axis 165 prior to mounting on the blade housing 115. The assembled blade centering assembly 1500 is configured to rotatably attach to the blade housing, for example, via a fastener (not shown) that can threadably attach within the recess 1596 in the spindle shaft 1550. The recess 1596 is illustrated in FIG. 16 as internally threaded to accept the fastener.

Referring to FIG. 17, the assembled blade centering assembly 1500 with the blade 150 secured within is shown mounted on the blade housing 115. The blade 150 when so coupled to the blade housing 115 is free to rotate relative to the blade housing 115, for example, via a bearing disposed between the fastener and the assembled blade centering assembly 1500. In other embodiments a portion of the blade housing 115 to which the blade centering assembly 1500 attaches is free to rotate relative to the rest of the blade housing 115.

While the present disclosure has been described with reference to one or more particular implementations, those skilled in the art will recognize that many changes may be made thereto without departing from the spirit and scope of the present disclosure. Each of these embodiments and implementations and obvious variations thereof is contemplated as falling within the spirit and scope of the present disclosure, which is set forth in the claims that follow.

What is claimed is:

1. A device for cutting material, comprising:
a carriage comprising a connecting leaf;
a blade (i) coupled to the connecting leaf, (ii) rotatable about a blade axis, and (iii) comprising a cutting edge;
an anvil (i) coupled to the connecting leaf, (ii) rotatable about an anvil axis, and (iii) comprising an outer rim, wherein the outer rim is adapted to engage the cutting edge; and
wherein the blade and the anvil are configured to rotate and cut material received between the cutting edge and outer rim, thereby introducing a cut line that forms substantially along a cut axis, wherein a leading edge of the connecting leaf follows the cut line as it is formed and passes through the cut.

2. The device of claim 1 further comprising:
a support table having (i) opposing upper and lower surfaces and (ii) a slot disposed along the cut axis through the support table, the slot extending between first and second regions of the support table;
the blade axis and a first portion of the connecting leaf disposed above the upper surface;
the anvil axis and a second portion of the connecting leaf disposed below the lower surface; and
a middle portion of the connecting leaf extends through the slot from the upper surface to the lower surface.

3. The device of claim 2, wherein
the anvil further comprises an inner rim rotatable about the anvil axis that is disposed radially inward relative to the outer rim;
the support table further comprises a rail surface on the lower surface of the support table, the rail surface extending along opposite sides of the slot;
the inner rim is adapted to engage the rail surface; and
wherein when the carriage travels in a first direction
(i) engagement between the inner rim and rail surface causes the anvil to rotate; and
(ii) engagement between the outer rim and cutting edge causes the blade to rotate.

4. The device of claim 3, wherein motion of the carriage in the first direction at a carriage velocity results in each of the outer rim and the cutting edge having a tangential velocity that exceeds the carriage velocity, thereby causing the outer rim and cutting edge to pull the material toward the leading edge of the connecting leaf.

5. The device of claim 2, further comprising an upper leaf clamp attaching the connecting leaf to a blade housing of the carriage, and a lower leaf clamp attaching the connecting leaf to an anvil housing of the carriage.

6. The device of claim 5, wherein the anvil housing includes the anvil at a first end, is pivotably connected to a shuttle carriage at a second end opposite the first end, and the first end of the anvil housing is biased toward the blade by a spring.

7. The device of claim 5, wherein the lower leaf clamp includes a sliding guide configured to slide within the slot.

8. The device of claim 1 further comprising:
a second blade (i) coupled to the connecting leaf, (ii) rotatable about a second blade axis, and (iii) comprising a second cutting edge;
a second anvil (i) coupled to the connecting leaf, (ii) rotatable about a second anvil axis, and (iii) comprising a second outer rim, wherein the second outer rim is adapted to engage the second cutting edge; and
wherein when the carriage travels in a second direction substantially opposite the first direction, the second blade and second anvil are adapted to rotate and cut material received between the second cutting edge and second outer rim.

9. The device of claim 1 further comprising:
a support table having (i) opposing upper and lower surfaces and (ii) a slot disposed along the cut axis through the support table, the slot extending between first and second regions of the support table;
the anvil axis and a first portion of the connecting leaf disposed above the upper surface;
the blade axis and a second portion of the connecting leaf disposed below the second surface;
a middle portion of the connecting leaf extends through the slot from the upper surface to the lower surface;
the blade is biased toward the anvil; and
at least a portion of the cutting edge is disposed within the slot.

10. The device of claim 1, wherein the blade is removably coupled to the connecting leaf via a blade centering assembly that rotatably couples the blade to a blade housing attached to the connecting leaf.

11. The device of claim 10, wherein the blade includes a center bore that includes the blade axis, and wherein the blade centering assembly comprises a blade collar configured to contact a first side of the blade and having a spindle shaft configured to pass through the center bore, a collet disposed around the spindle shaft and configured such that a first tapered end of the collet is disposed within the center bore of the blade, a Belleville washer disposed around the spindle shaft such that a first side of the Bellevue washer faces a second end of the collet, a centering clamp disposed around the spindle shaft and facing a second side of the Bellevue washer, and a threaded fastener threadably disposed into a recess in the spindle shaft such that a head of the threaded fastener forces the centering clamp into engagement with a second side of the blade against a bias of the Bellevue washer.

12. The device of claim 11, wherein the blade centering assembly maintains the blade concentrically on the spindle shaft and is configured to rotatably couple to the blade housing via a threaded fastener.

13. A device for cutting material, comprising:
a carriage comprising a connecting leaf;
a first blade (i) coupled to the connecting leaf, (ii) rotatable about a blade axis, and (iii) comprising a first cutting edge;
a second blade (i) coupled to the connecting leaf, (ii) rotatable about an anvil axis, and (iii) comprising a second cutting edge, wherein the first cutting edge is adapted to engage the second cutting edge; and
wherein when the carriage travels in a first direction:
(i) the first and second blades rotate and impart a shearing force that cuts material received between the first and second cutting edges, thereby introducing a cut line that forms substantially along a cut axis; and
(ii) a leading edge of the connecting leaf follows the cut line being formed and passes through the cut.

14. A device for cutting material, comprising:
a carriage having a blade housing and an anvil housing, the blade housing and the anvil housing connected by a connecting leaf;
a blade rotatably coupled to the blade housing about a blade axis via a blade centering assembly, the blade including a cutting edge;
an anvil rotatably coupled to the anvil housing about an anvil axis, the anvil including an outer rim configured to engage the cutting edge;
wherein the blade and the anvil are configured to rotate and cut material received between the cutting edge and outer rim, thereby introducing a cut line that forms substantially along a cut axis, wherein a leading edge of the connecting leaf follows the cut line as it is formed and passes through the cut.

15. The device of claim 14 further comprising:
a support table having (i) opposing upper and lower surfaces and (ii) a slot disposed along the cut axis through the support table, the slot extending between first and second regions of the support table;
the blade axis and a first portion of the connecting leaf disposed above the upper surface;
the anvil axis and a second portion of the connecting leaf disposed below the lower surface; and
a middle portion of the connecting leaf extends through the slot from the upper surface to the lower surface.

16. The device of claim 15, wherein
the anvil further comprises an inner rim rotatable about the anvil axis that is disposed radially inward relative to the outer rim;
the support table further comprises a rail surface on the lower surface of the support table, the rail surface extending along opposite sides of the slot;
the inner rim is adapted to engage the rail surface; and
wherein when the carriage travels in a first direction
(i) engagement between the inner rim and rail surface causes the anvil to rotate; and
(ii) engagement between the outer rim and cutting edge causes the blade to rotate.

17. The device of claim 16, wherein motion of the carriage in the first direction at a carriage velocity results in each of the outer rim and the cutting edge having a tangential velocity that exceeds the carriage velocity, thereby causing the outer rim and cutting edge to pull the material toward the leading edge of the connecting leaf.

18. The device of claim 15, further comprising an upper leaf clamp attaching the connecting leaf to a blade housing of the carriage, and a lower leaf clamp attaching the connecting leaf to an anvil housing of the carriage, wherein the anvil housing includes the anvil at a first end, is pivotably connected to a shuttle carriage at a second end opposite the first end, and the first end of the anvil housing is biased toward the blade by a spring, and wherein the lower leaf clamp includes a sliding guide configured to slide within the slot.

19. The device of claim 14, wherein the blade includes a center bore that includes the blade axis, and wherein the blade centering assembly comprises a blade collar configured to contact a first side of the blade and having a spindle shaft configured to pass through the center bore, a collet disposed around the spindle shaft and configured such that a first tapered end of the collet is disposed within the center bore of the blade, a Belleville washer disposed around the spindle shaft such that a first side of the Bellevue washer faces a second end of the collet, a centering clamp disposed around the spindle shaft and facing a second side of the Bellevue washer, and a threaded fastener threadably disposed into a recess in the spindle shaft such that a head of the threaded fastener forces the centering clamp into engagement with a second side of the blade against a bias of the Bellevue washer.

20. The device of claim 19, wherein the blade centering assembly maintains the blade concentrically on the spindle shaft and is configured to rotatably couple to the blade housing via a threaded fastener.
